(19) United States
(12) Patent Application Publication
(10) Pub. No.: US 2014/0087022 A1
(43) Pub. Date: Mar. 27, 2014

(54) NON-STICK CHEWING GUM

(71) Applicant: Kenneth S. Lin, San Marino, CA (US)

(72) Inventor: Kenneth S. Lin, San Marino, CA (US)

(21) Appl. No.: 13/307,900

(22) Filed: Nov. 30, 2011

Related U.S. Application Data
(60) Provisional application No. 61/418,839, filed on Dec. 1, 2010.

(51) Int. Cl. A23G 4/06

(52) U.S. Cl. 426/4; 426/3

(57) ABSTRACT

A non-stick chewing gum is disclosed. More specifically, a gum base is mixed with at least one pulverized natural food product that increases removability of the gum cud without sacrificing chewing sensation. In one embodiment, the particle size of the pulverized natural products containing fiber and other components (e.g. beans, fruit, nuts, vegetables, spices, ginseng, etc.) can range from 10 to 2000 microns in dimension before the chewing gum is chewed. The particles of the natural products can generate steric hindrance between the gum base and a contacted surface to reduce interfacial contact area therebetween and further enhance detackification effect of the chewing gum.

### CROSS-REFERENCE TO RELATED APPLICATIONS

This application claims priority under 35 U.S.C. §119 (e) to U.S. Provisional Patent Application Ser. No. 61/418,839, filed on Dec. 1, 2010, the entire contents of which are hereby incorporated by reference.

### FIELD OF THE INVENTION

This invention relates to a chewing gum. More specifically, this invention relates to a non-stick chewing gum having a gum base mixing with pulverized natural products containing fibers and other components with limited water solubility to increase removability of a gum cud without sacrificing chewing sensation.

### BACKGROUND OF THE INVENTION

A chewing gums generally includes a gum base, water-soluble components such as sugar or sugar substitutes, flavoring and/or some surfactants and processing aids. Typical chewing process usually takes ten to twenty minutes in the mouth, and once the chewing gum has been chewed and moistened, the water-soluble components are dissolved and ingested by the human body while the remaining gum cud is highly sticky to surfaces such as paper, floors, walls, clothes and furniture, etc. If the gum cud is not disposed properly, it can significantly pollute the environment because it is so difficult to be removed from the surfaces and it may cost taxpayers several millions a year to just clean up. Therefore, it is desirable to develop a new and improved chewing gum formulation that after chewing, the gum cud has a much lower adhesion force to various surfaces, so that it would be easily removed.

The gum cud is a soft viscoelastic material like pressure sensitive adhesives, so it sticks to almost all surfaces. The stickiness or adhesion of the gum cud is due to the interaction between the gum cud and the surfaces. More specifically, the adhesion between the gum cud and the contacted surface is directly proportional to the amount of “intimate interfacial contact area” of the polymer chains of the gum cud and the contacted surface. Once the intimate interfacial contact at the molecular level is formed, the interfacial adhesion force is substantially high and the polymer chains in the gum cud provide cohesive strength to make the gum cud hard to remove. The adhesion mechanism may involve mechanical effects and hydrogen bondings. For example, the adhesion can be influenced by wettability of the surface, surface tension and conditions of the surface (e.g. rough or smooth).

Over the years, scientists have developed a number of methods to prevent intimate contact between the polymer chain of the gum cud and the contacted surface. One approach is to increase the hardness of the gum cud by increasing the modulus of the gum base or adding more solid fillers in the gum formulation, so that the gum cud does not stick well to the surface. This approach has also been disclosed in U.S. Pat. No. 4,452,820 and U.S. Pat. No. 6,599,542. However, this is not a desirable approach since the harder gum base does not provide good chewing sensation. Even though the hardness of the gum cud can be increased to a certain degree to enhance the removability, but the unpleasant chewing sensation will definitely stop the consumers and adversely affect the market.

U.S. Pat. App. No.: 2010/0215799 discloses a chewing gum base having a polymeric material that has a straight or branched chain carbon-carbon backbone and a multiplicity of side chains to adjust the contact angle between the gum cud and the contacted surface. More particularly, the gum cud would not stick well to a surface if it has higher surface tension than the contacted surface and thus forms an unfavorable contact angle for wetting the surface. However, the surface tension of most gum cuds made by organic materials is lower than or about equal to most contacted surfaces like concrete, fabric and paper, so this approach may not be effective.

As stated above, it is difficult to remove the gum cud on the surface because an intimate interfacial contact at the molecular level is formed therebetween. So, an approach has been recently proposed to reduce the interfacial contact area by increasing the roughness thereof to enhance gum cud removability. U.S. Pat. App. No.: 2011/0123672 discloses gum bases contain microparticles including a crosslinked polymer, and the gum cud with microparticles can be removed more easily from contacted surfaces than gum cuds comprising conventional gum bases. This approach may be effective, however, these particles are chemically synthesized and may not be desirable for food consumption.

In addition to the patents and patent application publications mentioned above regarding non-stick chewing gums, U.S. Pat. No. 4,582,707 suggests adding carboxymethyl cellulose into chewing gum made with hydrogenated starch hydrolysate, alone, or with glycerine to prevent the chewing gum from being sticky. U.S. Pat. No. 5,601,858 discloses a non-stick chewing gum base composition which is free from fats, waxes, and elastomer solvent resins, and the resulting chewing gum can be easily removed from a variety of surfaces. More recently, Sozzi et al. to U.S. Pat. No. 7,871,650 discloses a non sticky gum base for chewing gum with good sensory properties and good flavor release in combination with anti-adhesive properties without containing polyvinyl acetate that makes the gum base more natural.

The non-stick chewing gums disclosed in the above-mentioned patents and patent application publications are disadvantageous since some of them are made by chemical synthetic processes to create crosslinked microparticles to enhance removability, however, these gums are less desirable for food consumption. Also, food grade materials such as beans, nuts, fruits, etc. are unlikely to be added into such chemical processes to provide completely natural and safe chewing gums for human consumption. On the other hand, even though some non-stick chewing gums stated above are made with natural components, the removability of the gum cud is not as good as those utilizing microparticles.

Recently, a team at Bristol University has formulated a gum, Rev 7, which has the same taste and texture as normal chewing gum, but is water-soluble. Rev 7 contains a new amphiphilic comb copolymer made up of a polyisoprene backbone and grafts of poly (ethylene oxide). This amphiphilic graft copolymer will not only reduce its adhesion strength to surfaces, but also will degrade into more water-soluble polymeric components that can easily be rinsed away. However, as the non-stick chewing gums described above, Rev 7 is also chemically synthesized. In fact, Rev 7 gum cud does stick to various surfaces, but it is easy to be cleaned or removed from the surfaces with soap and water.

Therefore, there remains a need for a new and improved chewing gum and a chewing gum manufacturing process including pulverized natural products that contain fibers and other components with limited water solubility, which is not only safe for human consumption, but also enhances removability of the chewing gum without sacrificing chewing sensation.

### SUMMARY OF THE INVENTION

It is an object of the present invention to provide a chewing gum and a manufacturing process thereof to increase removability of the chewing gum by adding pulverized natural products that contain fibers (mostly hydrophilic fibers) and other components with limited water solubility including, but not limited to bean, fruit, nut, vegetable, spices, ginseng, etc.

It is another object of the present invention to provide a non-stick chewing gum and a manufacturing process thereof to enhance chewing pleasure, and the gum cud has very limited adhesion to various surfaces by adding natural hydrophilic fibers which can be soften by saliva in the mouth.

It is still another object of the present invention to provide a gum base mixing with hydrophilic fibers to improve removability thereof after the chewing process, wherein the water absorbed by the natural fiber in a disposed gum cud evaporates when exposed to the air, and the interfacial adhesion to the contacted surfaces is reduced as the gum cud becomes harder.

It is a further object of the present invention to provide a non-stick chewing gum and a manufacturing process thereof by adding pulverized natural fibers having particle size ranging from 10 to 2000 microns in diameter to generate steric hindrance between the gum cud and the surface to reduce wettability and further reduce stickiness.

It is still a further object of the present invention to provide a non-stick chewing gum having natural fibers that is not only safe and healthy to human bodies, but also environmental friendly.

According to one aspect of the present invention, a non-stick gum base comprises a gum base including rubber, tackifier and other water insoluble components; at least one natural product having natural hydrophilic fibers and other components with limited water solubility; one or more water-soluble components including sugar, sugar substitutes and glycerol; and one or more flavors, wherein the natural hydrophilic fibers are pulverized with particle size ranging from 10 to 2000 microns in diameter to generate steric hindrance between the gum base and a contacted surface to reduce interfacial contact areas therebetween and further reduce stickiness.

In one embodiment, the pulverized natural fiber can be obtained from, but not limited to beans, fruit, nuts, vegetables, spices and ginseng, etc. In another embodiment, the pulverized natural fiber may contain other natural components such as protein and fat and oil that can be used to generate steric hindrance as well as leaving non-sticky smaller molecules at the interface.

In another aspect, the present invention provides a method of manufacturing a chewing gum comprises steps of preparing a predetermined amount of gum base; heating the gum base to melt; pulverizing at least one natural product including fibers and other components with limited water solubility; and mixing a predetermined amount of pulverized natural product with the melted gum base.

The present invention together with the above and other advantages may best be understood from the following detailed description of the embodiments.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

This invention relates to a chewing gum, and more specifically, this invention relates to a chewing gum including pulverized natural fibers that increase removability of the chewing gum without sacrificing chewing sensation. The stickiness of the gum, after chewing, is greatly reduced when food grade particles of a suitable particle size and size distribution is incorporated in the gum formulation. The food particles are water swell-able but have limited water solubility, and the food particles would normally contain food grade fiber and other ingredients like oil, fat or natural surfactant that may help to reduce tackiness of the gum cud. At a suitable particle size range and hardness range, the addition of food particles does not interfere with the chewing sensation of the chewing gum. More importantly, the non-stick chewing gum made in this manner has no toxicity, and the enjoyment of gum chewing can be enhanced by choosing different kinds of the food particles.

Traditional chewing gum would contaminate the environment if the chewing gum is not properly disposed after the chewing process because the gum cud is highly sticky to many surfaces such as wall, floor, sidewalk, clothes, etc., and is very difficult to remove the gum cud from the surfaces. To increase the removability of the chewing gum, a number of “non-stick” chewing gums have been developed. However, many of the non-stick chewing gums are made through chemical synthetic processes that may not be safe for human consumption, nor environmental friendly. Also, food grade materials are unlikely to be added during the chemical synthetic processes. Therefore, there is a need for an improved non-stick chewing gum manufacturing process that is not only safe for human consumption, but also enhances the removability of the gum cud.

The present invention uses pulverized natural fibers (mostly hydrophilic fibers) as filler to produce a non-stick chewing gum. At a predetermined concentration of the filler with a specific range of particle size, the gum has good chewing sensation as well as good removability as to many kinds of surfaces. It is noted that the pulverized natural fiber particles in the present invention can be relatively large because it can be soften by saliva in the mouth and do not interfere with chewing sensation. In one embodiment, the formulated chewing gum in the present invention uses a regular commercial gum base plus commercial food powder. The food powder includes, but not limited to, baked soybean powder, baked sesame powder, baked peanut powder, etc. It is noted that the food powder added to the gum base is a completely safe food grade ingredient.

The size of the pulverized natural fiber (e.g. beans, fruit, nuts, vegetables, spices, ginseng, etc.) plays an important role to affect the removability of the gum cud. The food particles could be in powder form or even larger pieces. When the particle size is smaller than 1000 microns in diameter, the particles can be incorporated into the chewing gum matrix smoothly. After absorbing saliva in the mouth, the particles become soft and can be further broken down to smaller pieces by the chewing process without the feeling of being “gritty” in the mouth. Even if the particle size is more than 1000 microns initially, it can be broken down into smaller pieces that would be imbedded in the chewing gum matrix, and becomes non-gritty after a few minutes of chewing. However, to be effectively detackify the gum cud, the particle size needs to be at least 10 microns in diameter to effectively increase the roughness of the interface. It is noted that most particles in the gum cud are in the range of 10 to 500 microns in diameter, which is a very effective range in detackifying the gum cud.

Some inorganic fillers may be added into gum bases, but they may not be softened easily during the chewing process, and the chewing sensation becomes very gritty when the particle size of the inorganic filler is over 100 microns. Even though adding such inorganic fillers may enhance the chewing gum's removability, it may not be favorable in the market due to its gritty chewing sensation.

As discussed above, the adhesion between the gum base and the contacted surface is directly proportional to the amount of “intimate interfacial contact area” of the polymer chain and the contacted surface. The present invention is to use the particles of the pulverized natural fiber as “steric hindrance” between the gum base and the contacted surface to minimize the interfacial contact area and further reduce the adhesion of the gum base. Unlike some prior arts (e.g. US 2011/0123672 as can be seen above) utilizing chemically synthesized microparticles to enhance the removability of the gum cud, the present invention uses pulverized natural food as a filler to not only provide steric hindrance to enhance the removability of the gum cud, but also incorporate food grade materials to be safe for human to consume the chewing gum.

Typically, a gum base is melted at a temperature of about 115° C. (239° F.), until it has the viscosity of thick maple syrup. The gum base is put into a mixing vat to mix with other ingredients including powder sugar, softeners, flavorings and other additives. In one embodiment, the pulverized natural fibers can be added into the mixing vat when the gum base is still hot and melted. In another embodiment, the pulverized natural fibers can be blended with the clear gum base at a lower temperature. For example, baked soybeans are pulverized and blended with the gum base to generate a chewing gum cud that can be easily removed after chewing process from the contacted surface such as paper, clothes, floor, etc. It is noted that the natural fiber particles may contain other natural components such as proteins and oils which can also be used as “steric hindrance” and “lubricant” between the polymer chain in gum base and the contacted surfaces.

In order to further define and describe the present invention, a number of examples are provided to illustrate certain aspects and embodiments of the present invention, but do not limit the scope of the invention in any way.

### Example 1

Dentyne Ice (Peppermint flavor distributed by Cadbury Adams USA LLC) was used as an experimental gum, and the weight of each piece of the chewing gum was 1.5 grams. Baked soybean powder (made by Shin Tong Yang, Taiwan) was acquired from a grocery store. The soybean powder is actually additives to instant breakfast to increase its flavor and is safe food ingredients. Twelve (12) pieces of the chewing gum, totaling eighteen (18) grams of the Dentyne Ice, were heated to melt in a small non-stick pan and the chewing gum became a high viscosity molten liquid. 2.7 grams of the soybean powder (15% of the weight of the gum) was added to the molten Dentyne Ice and then mixed for 5 minutes. The mixture was poured onto a non-stick paper sheet, flattened into a sheet, and cooled down for about 30 minutes.

The mixture (1.5 grams) was then chewed for about 15 minutes before it was taken out from the mouth. A test of stickiness and adhesion of the gum cud was conducted on various substrates including printer paper, fabric (a cotton T-shirt), wood and concrete. During the test, the gum cuds were pressed strongly and repeatedly by thumb pressure on the substrates mentioned above. The results showed that the stickiness and adhesion of the gum cud with baked soybean powder (GUM-BSP1) was significantly reduced. More specifically, the gum cud was easily removed from the printer paper, cotton fabric, wood and concrete, and it did not even tear or deform the paper when removed. The result was compared side by side with a gum cud from commercial Dentyne Ice (GUM-CONV) as shown in Table 1, where “NSt” means non-sticky and easy to remove, and “St” means sticky and hard to remove.

TABLE 1
Stickiness test - GUM-BSP1 (Gum containing 15% of weight of
soybean powder) vs. GUM-CONV (Commercial Dentyne Ice)

| | GUM-BSP1 | GUM-CONV |
|---|---|---|
| Printer Paper | NSt | St |
| Cotton Fabric | NSt | St |
| Wood | NSt | St |
| Concrete | NSt | St |

### Example 2

In order to enhance the chewing sensation, the amount of the baked soybean powder was slightly reduced from 15% to 10% of the weight of the gum in Example 2. The purpose of this example is to enhance the chewing sensation by reducing the percentage of the baked soybean powder, while maintaining or improving the removability of the gum cud.

Fifteen (15) grams of Dentyne Ice (10 pieces) was heated to become a high viscosity melt, and 1.5 grams (10% of the weight of the gum) of baked soybean powder was added to the melt. The mixture was mixed for 5 minutes poured onto a non-stick paper sheet, flattened into a sheet, and cooled down for about 30 minutes as in the previous Example. 1.5 grams of the mixture was chewed in the mouth without pasty feeling while chewing. The chewing sensation was cohesive like a commercial chew gum, with a nice flavor of the additive. The same stickiness test in Example 1 was conducted to the gum cud with baked soybean powder (10% of the weight of the gum) (GUM-BSP2) and the gum cud from commercial Dentyne Ice (GUM-CONV). Similar result is shown in Table 2, where “NSt” means non-sticky and easy to remove, and “St” means sticky and hard to remove.

It is noted that after chewing 1.5 grams of the commercial Dentyne Ice (GUM-CONV) for 10 minutes, the water-soluble portion of the chewing gum was removed and the weight became 0.6 grams. After chewing the experimental gum (GUM-BSP2) for 10 minutes, the gum cud was 0.9 grams. We believe that the weight differences were due to higher saliva absorption by the added soybean powder in GUM-BSP2. The absorbed saliva water reduces the stickiness of the gum cud, and the baked soybean powder provides steric hindrance to prevent polymer chain in the gum cud to come in contact with the substrate surface at a molecular level, so that the removability of the gum cud can be significantly enhanced.

TABLE 2
Stickiness test - GUM-BSP2 (Gum containing 10% of weight of
soybean powder) vs. GUM-CONV (Commercial Dentyne Ice)

| | GUM-BSP2 | GUM-CONV |
|---|---|---|
| Printer Paper | NSt | St |
| Cotton Fabric | NSt | St |
| Wood | NSt | St |
| Concrete | NSt | St |

### Example 3

Similar experiment was performed using Wrigley's Doublemint Gum and we found that this gum base is softer than Dentyne Ice. However, the stickiness of the gum cud was again significantly reduced by adding baked soybean powder. The original gum cud was relatively soft, so it can be broken cohesively when removed from a hard substrate like concrete. However, it again showed that the gum cud did not stick to the printer paper, cotton fabric, wood and concrete by adding baked soybean powder (10% by weight of the chewing gum) as in Example 2. In other words, the gum cud can be removed in a much easier manner than commercial products.

### Example 4

Thirty (30) grams (20 pieces) of Trident White (distributed by Cadbury Adams USA LLC) was heated to melt, and 3.0 grams of sesame powder (10% of chewing gum weight) was added to the melt to mix for 5 minutes. The mixture was poured onto a parchment paper, flattened, and cooled down for about 30 minutes. The mixture was then cut into pieces and chewed for 10 minutes. Again, the gum cud showed excellent removability from printer paper, cotton fabrics, wood and concrete as in previous examples.

### Example 5

LIFU-DR gum bases were provided by Wuxi Gum Base Co. Ltd. In China. In this example, we compared the blank LIFU-DR gum base (LIFU) with the LIFU-DR gum base adding baked soybean powder (GUM-BSP5) in the stickiness test. The composition (by weight) of the blank LIFU-DR gum base and the chewing gum GUM-BSP5 is illustrated in Table 3 and Table 4, respectively.

Likewise, the stickiness test was again conducted on GUM-BSP5 and LIFU, and similar result was obtained by comparing the stickiness therebetween. The result in Table 5 again showed that GUM-BSP5 including baked soybean powder possesses much better removability than the blank gum base LIFU on various substrates due to the formation of “steric hindrance” between the gum cud and substrates. In this example, aged removability was also tested. The gum cud was applied on to a concrete surface and placed under the sun. The gum cud can be easily removed from the concrete surface after seven days.

TABLE 3
Composition of LIFU

| | Percentage (% in weight) |
|---|---|
| Wuxi LIFU-DR (Gum base) | 40% |
| Sorbital | 44% |
| Calcium Carbonate Filler | 8% |
| Glycerol | 5% |
| Peppermint Flavor | 3% |

TABLE 4
Composition of GUM-BSP5

| | Percentage (% in weight) |
|---|---|
| Wuxi LIFU-DR (Gum base) | 40% |
| Sorbital | 37% |
| Baked Soybean Powder | 10% |
| Calcium Carbonate Filler | 7% |
| Glycerol | 4% |
| Peppermint Flavor | 2% |

TABLE 5
Stickiness test - GUM-BSP5 (Gum containing 10% of weight of
soybean powder) vs. LIFU (Blank gum base)

| | GUM-BSP5 | GUM-CONV |
|---|---|---|
| Printer Paper | NSt | St |
| Cotton Fabric | NSt | St |
| Wood | NSt | St |
| Concrete | NSt | St |

Based on the results illustrated above, the removability of the gum cud is significantly enhanced by adding baked soybean powder as the filler. Also, the excellent removability does not vary with different gum bases. This result agrees with our reasoning that the soybean powder (after chewing) provides sufficient steric hindrance between the gum base and the contacted surface to significantly reduce interfacial contact areas therebetween to further reduce the stickiness of the gum cud. We repeated examples 1 to 5 with different fillers such as sesame powder, peanut powder, bean powder, etc., and the results of the stickiness test are similar as above. Since the mixing process of the filler and the gum base is totally natural without involving any chemical synthesis process, the filler can be any food grade materials that can be pulverized. In other words, the chewing gum in the present invention is not only environmental friendly, but also safe and healthy for human bodies.

Having described the invention by the description and illustrations above, it should be understood that these are exemplary of the invention and are not to be considered as limiting. Accordingly, the invention is not to be considered as limited by the foregoing description, but includes any equivalents.

1. A chewing gum comprising:
a gum base; and
at least one fiber-containing natural product obtained from a food material selected from the group consisting of beans, nuts, sesame, and peanuts,
wherein the fiber-containing natural product is pulverized to particles having a predetermined particle size, and the particles further include protein and oil, the protein and/or the oil is configured to survive that survives a chewing process to generate steric hindrance and interfacial slip effect between the particles and a general contacted surface to provide removability of a gum cud from said general contacted surface, without interfering with good chew sensation.

2. The chewing gum of claim 1, wherein the natural product is less than or about 25% by weight of the chewing gum.

3. The chewing gum of claim 2, wherein the natural product is from about 3% to 25% by weight of the chewing gum.

4. The chewing gum of claim 3, wherein the natural product is from 5% to 20% by weight of the chewing gum.

5. The chewing gum of claim 4, wherein the natural product is from 10% to 15% by weight of the chewing gum.

6.-8. (canceled)

9. The chewing gum of claim 1, wherein the particle size of the natural product is more than 10 micrometers in diameter before chewing.

10. The chewing gum of claim 2, wherein the particle size of the natural product is about 10 to 2000 micrometers in diameter before chewing.

11. (canceled)

12. The chewing gum of claim 1, wherein the particle size of the natural product is about 10 to 500 micrometers in diameter after chewing.

13. The chewing gum of claim 2, wherein the particle size of the natural product is about 10 to 500 micrometers in diameter after chewing.

14. (canceled)

15. The chewing gum of claim 1, wherein the fiber of the fiber-containing natural product is hydrophilic fiber.

16. A method of manufacturing a chewing gum comprises steps of preparing a predetermined amount of gum base; heating the gum base to melt; pulverizing at least one natural product including fibers and other components; and mixing a predetermined amount of pulverized natural product with the melted gum base.

17. The chewing gum of claim 1, wherein the contacted surface is selected from the group consisting of paper, floors, walls, clothes and furniture.

18. The chewing gum of claim 1, wherein the fiber-containing natural product is a commercial food powder.

19. The chewing gum of claim 18, wherein the commercial food powder is baked soybean powder, baked sesame powder, or baked peanut powder.
